(19) United States
(12) Patent Application Publication
(10) Pub. No.: US 2020/0406306 A1
(43) Pub. Date: Dec. 31, 2020

(54) SELF-CLEANING AUTOMATICALLY-STORED ELECTRICAL MOP

(71) Applicant: SHENZHEN JASHEN TECHNOLOGY CO., LTD., SHENZHEN (CN)

(72) Inventors: Zhi-Chang LIU, SHENZHEN (CN); Xiao-Ming ZHANG, SHENZHEN (CN); Jian-Xin XI, SHENZHEN (CN)

(21) Appl. No.: 16/560,503

(22) Filed: Sep. 4, 2019

(30) Foreign Application Priority Data
Jun. 25, 2019 (CN) 201910560001.4
Jun. 25, 2019 (CN) 201910560059.9
Jun. 26, 2019 (CN) 201910564423.9
Jun. 26, 2019 (CN) 201910565112.4
Jun. 26, 2019 (CN) 201910566387.X

(51) Int. Cl. B08B 3/04; A47L 11/292; A47L 13/22; A47L 13/58; B08B 1/00; B08B 1/02

(52) U.S. Cl. CPC B08B 3/041; A47L 11/292; A47L 13/22; B08B 1/02; B08B 1/005; B08B 1/007; A47L 13/58

(57) ABSTRACT

A self-cleaning automatically-stored electrical mop includes a mop rod assembly, a mop head assembly, and a cleaning base assembly used for storing and cleaning the mop head assembly. The mop head assembly is arranged at the lower end of the mop rod assembly and includes a mop head shell which is provided with a rotatable cleaning roller and a motor used for driving the cleaning roller. The cleaning base assembly includes a shell part. A cleaning groove used for cleaning the cleaning roller is formed in the shell part, and a cleaning assembly used for scrubbing the cleaning roller is arranged in the cleaning groove. The shell part is provided with a sewage discharge system used for discharging sewage.

### BACKGROUND OF THE INVENTION

### 1. Technical Field

The invention relates to mops, in particular to a self-cleaning automatically-stored electrical mop.

### 2. Description of Related Art

Mops are common domestic cleaning tools and mainly comprise a mop rod to be held and a mop head used for cleaning. With the development of science, various more electrical and intelligent mops have come into being.

Existing mops provided with one bar-shaped mop rod are designed according to human body heights, and the whole mop rod is very long in general. Today, e-commerce is becoming more and more well-developed, while the long mop rod which inconvenient to package and transport may cause a high cost when transported due to its large size.

Direct cleaning of the mops depends on cleaning parts which are located on the mop heads and are made of cloth strips or sponge rollers according to different designs. In use, the existing mop heads have the shortcoming of manual cleaning of the mop heads and the cleaning parts after floor cleaning, which in turn leads to complex operation, stains to hands and inconvenient usage. Besides, the cleaning parts of the existing mops are fixed, and when one contact surface is stained due to floor mopping, the mops need to be turned upside down to continuously clean the floor by means of another clean surface, which leads to inconvenient operation.

### BRIEF SUMMARY OF THE INVENTION

The objective of the invention is to solve the problems of complex operation and hand stains caused by manual cleaning of the cleaning parts of mops in the prior art by providing a self-cleaning automatically-stored electrical mop which adopts a rotatable roller used for cleaning the floor as a cleaning part of a mop head, uses a cleaning base assembly provided with a cleaning groove to clean the cleaning part of the mop head, and is able to realize self-cleaning by means of the rotation of the cleaning roller during cleaning, thereby avoiding inconvenience and pollution caused by manual cleaning; meanwhile, a cleaning assembly is arranged in the cleaning base assembly to assist in scrubbing and cleaning the roller, so that the cleaning effect is further improved, and the whole electrical mop is convenient to use and has a good effect.

To fulfill the above-mentioned objective, the invention provides a self-cleaning automatically-stored electrical mop which comprises a mop rod assembly, a mop head assembly, and a cleaning base assembly used for storing and cleaning the mop head assembly, wherein the mop head assembly is arranged at the lower end of the mop rod assembly and includes a mop head shell which is provided with a rotatable cleaning roller and a motor used for driving the cleaning roller; the cleaning base assembly includes a shell part; and a cleaning groove used for cleaning the cleaning roller is formed in the shell part, a cleaning assembly used for scrubbing the cleaning roller is arranged in the cleaning groove, and the shell part is provided with a sewage discharge system used for discharging sewage.

Preferably, the motor is connected to the cleaning roller through a transmission assembly; the transmission assembly includes a change gear set, a transmission belt, and a roller connector which are sequentially connected; the roller connector is rotatably arranged on the mop head shell; and the cleaning roller is assembled on the roller connector.

Preferably, the mop rod assembly includes at least two connecting sections which are detachably connected.

Preferably, the mop rod assembly includes three connecting sections, the three sections are respectively a handle assembly, an upper rod assembly, and a lower rod assembly which are sequentially and detachably connected, and the mop head assembly is detachably connected to the lower rod assembly.

Preferably, the handle assembly includes a handle shell, and an insertion section is formed at the lower end of the handle shell and is provided with an elastic arm connected to the upper rod assembly; the upper rod assembly includes an upper rod shell, wherein an upper insertion groove allowing the insertion section to be inserted therein is formed in one end of the upper rod shell, a clamping groove matched with the elastic arm is formed in the side wall of the upper insertion groove, and the upper rod shell is provided with a handle release button used for releasing the elastic arm; the handle release button includes a button cap and a button rod stretching into the clamping groove; the button cap penetrates through a wall plate of the upper rod shell, and a limit protrusion matched with the wall plate is arranged on the lower edge of the button cap; and the upper insertion groove is defined by an insertion groove wall plate, the clamping groove is formed in the internal wall of the insertion groove wall plate, the button rod is sleeved with a return spring, and the return spring has an end abutting against the button cap as well as an end abutting against the external surface of the insertion groove wall plate.

Preferably, an elastic piece having a concave surface as the clamping groove is embedded into the side wall of the insertion groove, and the handle release button includes a button cap and a button rod which extrudes the elastic piece to deform, so that the elastic arm is disengaged from the concave surface to be released.

Preferably, the upper rod assembly includes the upper rod shell, and the lower rod assembly includes a lower rod shell; and an insertion part inserted into the upper rod shell is formed at one end of the lower rod shell, a lower insertion groove allowing the insertion part to be inserted therein is correspondingly formed in one end of the upper rod shell, and a mop head insertion groove allowing the mop head shell to be inserted therein is formed in one end of the lower rod shell.

Preferably, the insertion part is fixed into the lower insertion groove through a bolt.

Preferably, a water pump used for discharging cleaning water is arranged on the mop head shell and has an output end connected to a nozzle arranged on the mop head shell, and the water outlet end of the nozzle stretches out of the mop head shell.

Preferably, a positioning slot used for storing the cleaning roller is formed in the cleaning groove.

Preferably, the bottom surface of the cleaning groove is oblique.

Preferably, the cleaning assembly includes a water-squeezing scraper strip arranged on the edge of the positioning slot.

A method for using the electrical mop comprises the following steps: 1, using the cleaning roller to clean the floor; 2, placing the mop head assembly into the cleaning groove after usage, and placing the cleaning roller into the positioning slot, wherein the cleaning roller is submerged in water in the cleaning groove; 3, starting the motor to drive the cleaning roller to rotate to be cleaned, and scrubbing the cleaning roller by the water-squeezing scraper strip at the same time; and 4, discharging sewage out of the cleaning groove.

Preferably, the water pump is started to spray water or cleaning solutions to the floor to be cleaned before step 1.

The detailed structures or characteristics of the invention will be explained in the detailed description of the invention. However, those skilled in this field should appreciate that the detailed description and specific embodiments illustrated are only used for explaining the invention, and are not intend to limit the protection scope of the claims of the invention.

### BRIEF DESCRIPTION OF THE SEVERAL VIEWS OF THE DRAWINGS

FIG. 1 is an assembled perspective view of a preferred embodiment of the invention;

FIG. 2 is an exploded perspective view of the preferred embodiment of the invention;

FIG. 3 is a partial perspective view of the preferred embodiment of the invention, mainly showing a handle assembly of a mop rod;

FIG. 4 is a partial sectional view of the preferred embodiment of the invention, mainly showing the handle assembly of the mop rod;

FIG. 5 is a partial front view of the preferred embodiment of the invention, mainly showing the internal structure of an upper rod assembly of the mop rod;

FIG. 6 is a partial sectional view of the preferred embodiment of the invention, mainly showing the internal structure of the upper rod assembly of the mop rod;

FIG. 7 is an enlarged view of part A in FIG. 6;

FIG. 8 is partial front view of the preferred embodiment of the invention, mainly showing the configuration of a handle release button;

FIG. 9 is an enlarged view of part E in FIG. 8;

FIG. 10 is partial front view of the preferred embodiment of the invention, mainly showing the structure of a lower rod assembly of the mop rod;

FIG. 11 is a partial sectional view of the preferred embodiment of the invention, mainly showing the internal structure of the lower rod assembly of the mop rod;

FIG. 12 is an enlarged view of part B in FIG. 11;

FIG. 13 is partial exploded perspective view of the preferred embodiment of the invention, mainly showing the exploded structure of a mop head assembly;

FIG. 14 is an enlarged view of part C in FIG. 13;

FIG. 15 is a partial sectional view of the preferred embodiment of the invention, mainly showing the internal structure of the mop head assembly;

FIG. 16 is a schematic diagram of a cleaning base assembly in the preferred embodiment of the invention;

FIG. 17 is an exploded view of the cleaning base assembly in the preferred embodiment of the invention;

FIG. 18 is a schematic diagram for cooperative configuration of the cleaning base assembly and the mop head assembly in the preferred embodiment of the invention;

FIG. 19 is another schematic diagram for cooperative configuration of the cleaning base assembly and the mop head assembly in the preferred embodiment of the invention;

FIG. 20 is a schematic diagram of a circuit system in the preferred embodiment of the invention.

### DETAILED DESCRIPTION OF THE INVENTION

The technical contents and characteristics of the invention are expounded as follows with reference to preferred embodiments and the accompanying drawings. The invention is mainly applied to electrical mops and wet-type electrical mops. Those skilled in this field would appreciate that descriptive terms in this embodiment are generic descriptions having no limitation on the application field. For instance, material or shape terms include, but are not limited to, materials or shapes specified in the description, and positional terms include, but are not limited to, “arrange”, “near”, “connect”, and “abut”. The number term “one”, which indicates the number of assemblies, indicates one or more assemblies included. Directional terms such as “upper”, “lower”, “internal”, “external”, “top”, and “bottom” in the specification are only illustrative ones based on the normal using direction, and are not intended to limit the scope claimed by the invention.

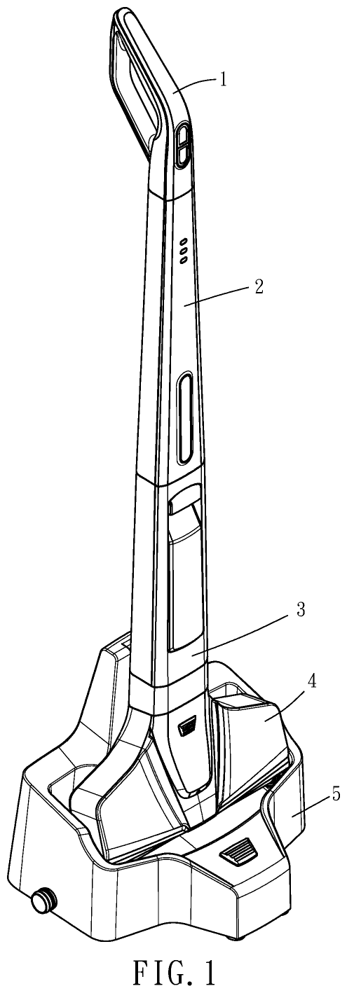

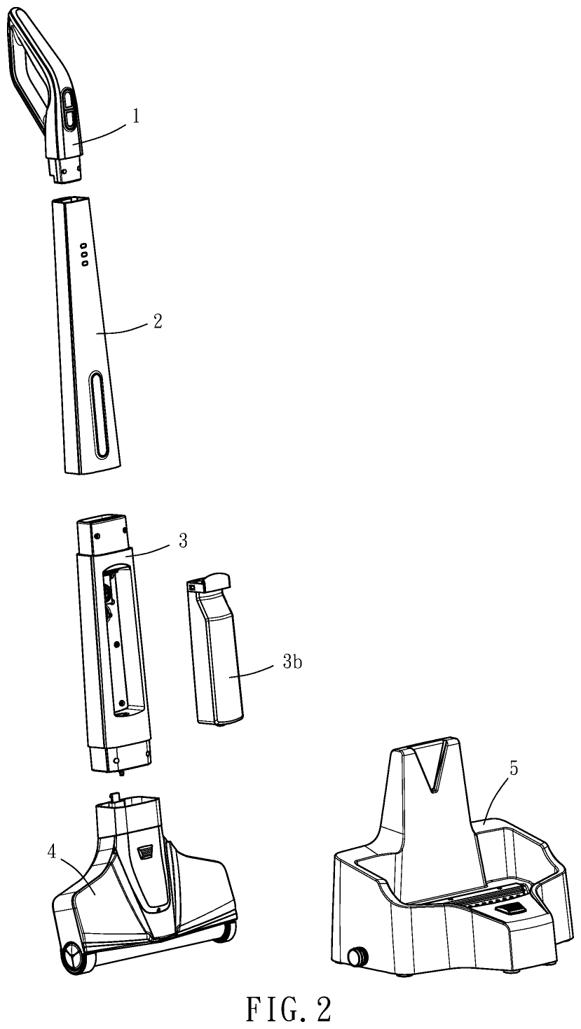

As shown in FIG. 1 and FIG. 2, a self-cleaning automatically-stored electrical mop comprises a mop rod assembly, a mop head assembly 4, and a cleaning base assembly 5, wherein the mop rod assembly is provided with a handle assembly 1, an upper rod assembly 2, and a lower rod assembly 3, the mop head assembly 4 is arranged at the lower end of the mop rod assembly, and the cleaning base assembly 5 is used for storing and cleaning the mop head assembly 4. The mop rod assembly includes at least two connecting sections which are detachably connected.

In order to reduce the overall package size to facilitate packaging and transportation, the mop rod assembly is formed by a plurality of detachable sections, and the number of the sections is determined according to the design. As a preferred solution, the mop rod assembly in this embodiment includes three connecting sections which are respectively the handle assembly 1, the upper rod assembly 2, and the lower rod assembly 3 which are sequentially and detachably connected, and the mop head assembly 4 is detachably connected to the lower rod assembly 3.

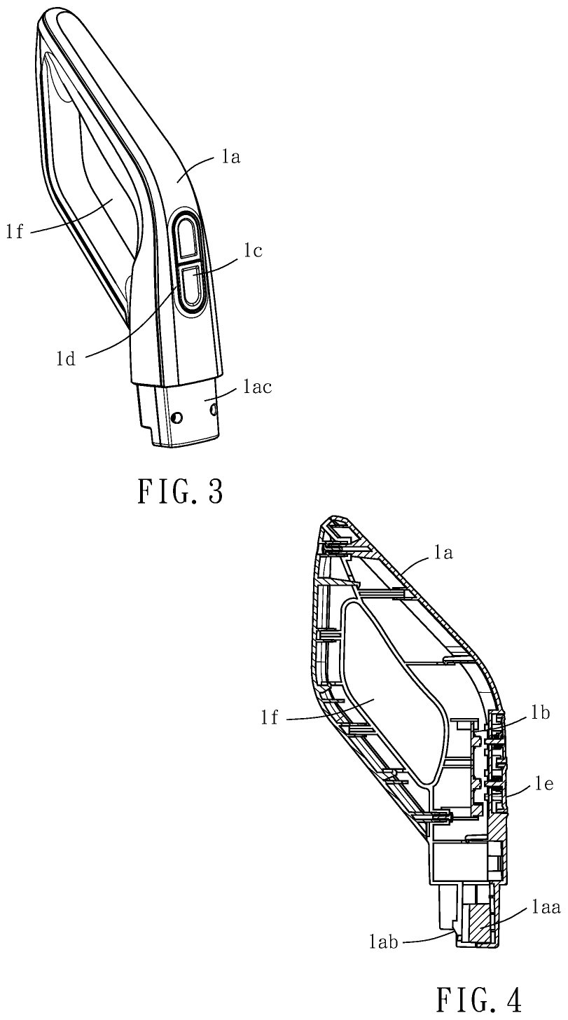

As shown in FIG. 3 and FIG. 4, the handle assembly 1 is provided with a hollow handle shell 1a, a tubular insertion section 1aa is formed at the lower end of the handle shell 1a, the inside of the handle shell 1a is communicated with the outside through the insertion section 1aa, an elastic arm 1ab used for connection and clamping is formed on the insertion section 1aa, and a protrusion used for connection and clamping is formed on the external surface of the elastic arm 1ab. Preferably, a switch circuit board 1b is arranged in the handle shell 1a, and correspondingly, the handle shell 1a is provided with switch buttons 1c. Preferably, a switch button hole is formed in a position, where the switch buttons 1c are to be arranged, of the handle shell 1a, a button board 1d is arranged at the switch button hole, and the switch buttons 1c are arranged on the button board 1d and inwards penetrate through the button board 1d to stretch into the handle shell 1a. Preferably, the button board 1d is buckled on the edge of the switch button hole through a buckling structure. Preferably, a button return spring 1e is arranged between the switch buttons 1c and the button board 1d. Preferably, the switch buttons 1c include a motor button and a water pump button. Preferably, the handle shell 1a is bent to form a handle ring if to be held.

The specific structure of the handle assembly is given in this embodiment, wherein the handle shell 1a is used as a main part, and related accessories such as the switch circuit board 1b are arranged in the hollow handle shell 1a. The insertion section 1aa is inserted into the upper rod assembly 2 and is buckled through the protrusion on the elastic arm 1ab. The switch circuit board 1b constitutes one part of a switch circuit and fulfills on-off control in cooperation with the switch buttons 1c. The switch buttons 1c are specifically configured through the button board 1d. The button board 1d is buckled on the edge of the switch button hole, thereby being convenient to assemble and disassemble. The button return spring 1e allows the switch buttons 1c to be pressed to return, and when an external force for pressing disappears, the switch buttons 1c return under the action of the button return spring 1e. In this solution, the switches are mainly used for controlling a motor and a water pump, and accordingly, the motor button and the water pump button are configured. The handle ring if is configured to be conveniently held by users.

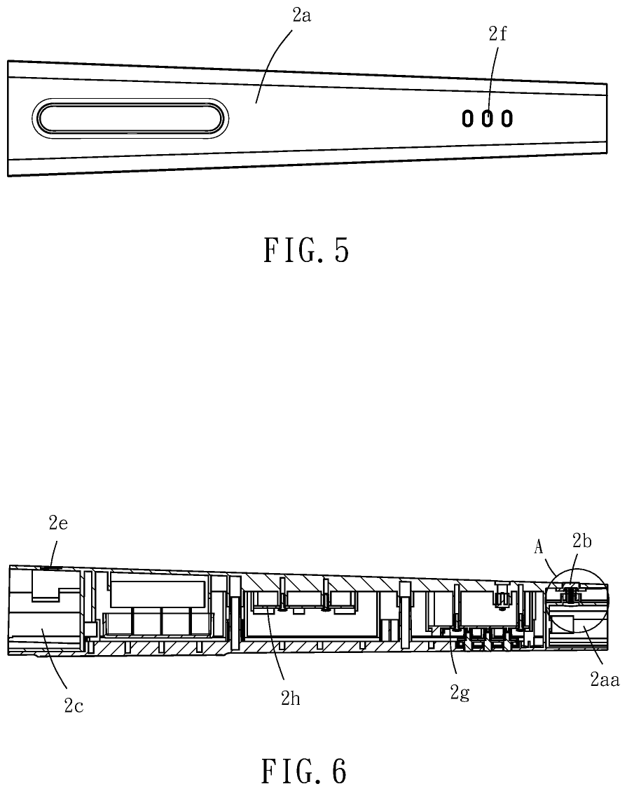

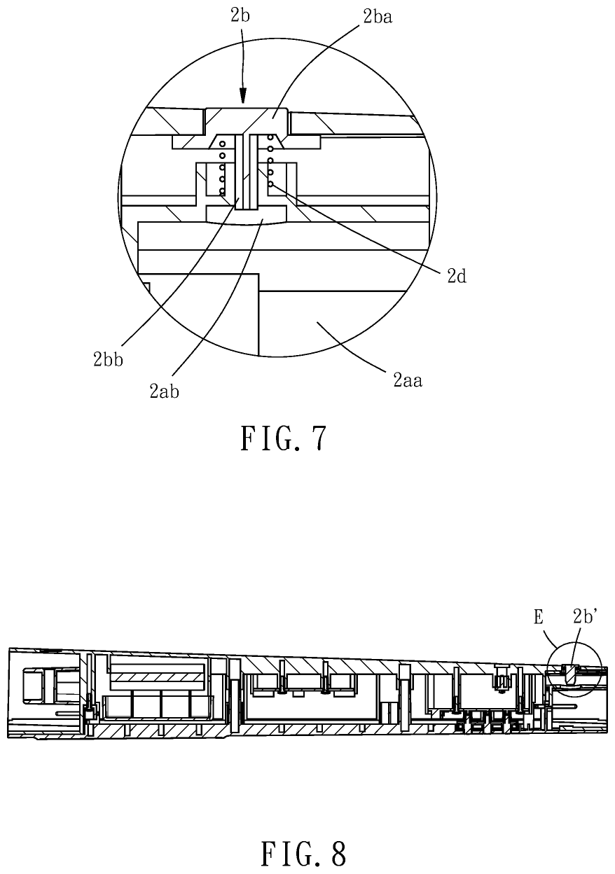

As shown in FIG. 5, FIG. 6, and FIG. 7, the upper rod assembly 2 is provided with an upper rod shell 2a, an upper insertion groove 2aa allowing the handle assembly 1 to be inserted therein is formed in one end of the upper rod shell 2a, a clamping groove 2ab matched with the elastic arm 1ab is formed in the side wall of the upper insertion groove 2aa, and a handle release button 2b used for releasing the elastic arm 1ab is arranged on the upper rod shell 2a and has an end stretching into the clamping groove 2ab; and a lower insertion groove 2c allowing the lower rod assembly 3 to be inserted therein is formed in the other end of the upper rod shell 2a. Preferably, the handle release button 2b includes a button cap 2ba and a button rod 2bb stretching into the clamping groove 2ab. Preferably, the button cap 2ba penetrates through a wall plate of the upper rod shell 2a, and a limit protrusion matched with the internal surface of the wall plate is arranged on the lower edge of the button cap 2ba. Preferably, the upper insertion groove 2aa is defined by an insertion groove wall plate, the clamping groove 2ab is formed in the internal wall of the insertion groove wall plate, the button rod 2bb is sleeved with a return spring 2d, and the return spring 2d has an end abutting against the button cap 2ba as well as an end abutting against the external surface of the insertion groove wall plate. Preferably, a first bolt hole 2e used for fixing the lower rod assembly 3 is formed in the upper rod shell 2a and extends into the lower insertion groove 2c. Preferably, the upper rod shell 2a is provided with an indicator light 2f, and an indicator light panel 2g connected with the indicator light 2f is arranged in the upper rod shell 2a. Preferably, a main control panel 2h is arranged in the upper rod shell 2a.

The specific structure of the upper rod assembly 2 is given in this embodiment, wherein the upper rod shell 2a is used as a main part of the upper rod assembly 2 and has an upper end connected with the handle assembly 1 and a lower end connected with the lower rod assembly 3, and specifically, the upper rod shell 2a is connected with the insertion section 1aa on the handle shell 1a in an insertion manner through the upper insertion groove 2aa and is clamped in the clamping groove 2ab through the elastic arm 1ab. The protrusion on the elastic arm 1ab is clamped in the clamping groove 2ab. When the upper rod assembly 2 needs to be released, the handle release button 2b is pressed to move the button rod 2bb to extrude the elastic arm 1ab out of the clamping groove 2ab, and then the handle assembly 1 is pulled out. The handle release button 2b is pressed downwards for use and is pressed through the return spring 2d to return. In order to prevent the handle release button 2b from being pushed out by the return spring 2d and from being dropped from the upper rod shell 2a, the limit protrusion is arranged on the edge of the button cap 2ba to limit the wall plate of the upper rod shell 2a to fulfill anti-disengagement effect. In view of the electrical-control design of the mop, the indicator light 2f is adopted to display an electrical control state and is arranged on the upper rod shell 2a so as to be conveniently observed by users, and the corresponding indicator light panel 2g is arranged in the upper rod shell 2a to be matched with the indicator light 2f on circuit configuration. Similarly, on the basis of the electrical-control design of the mop, the main control panel 2h is arranged in the upper rod shell 2a to facilitate circuit configuration.

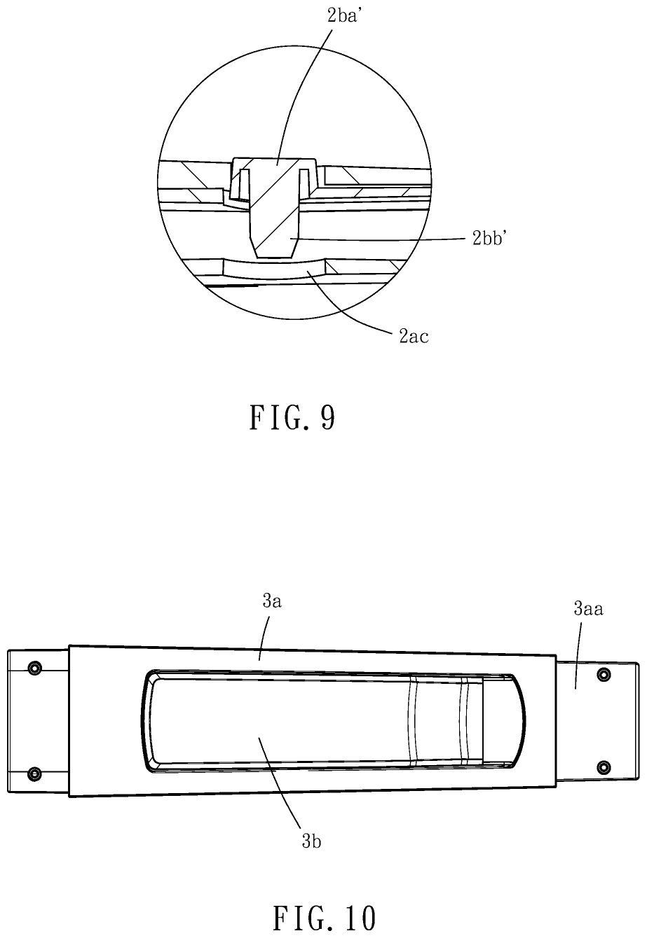

To reduce costs and to simplify the structure, as shown in FIG. 8 and FIG. 9, a handle release button 2b′ in another structural form is given. An elastic piece 2ac having a concave surface as the clamping groove 2ab is embedded into the side wall of the insertion groove 2aa, and the handle release button 2b′ includes a button cap 2ba′ and a button rod 2bb′ which extrudes the elastic piece 2ac to deform so that the elastic arm 1ab is disengaged from the concave surface to be released. The protrusion on the elastic arm 1ab is clamped in the concave surface of the elastic piece 2ac to form a fixed connection structure. The elastic piece 2ac enables the handle release button 2b′ to return through the elasticity of its own, and particularly, the elastic piece 2ac is made from a disc spring or a similar elastic structure. During specific use, the button rod 2bb′ extrudes the elastic piece 2ac under an external force, and then the protrusion on the elastic arm 1ab slides out of the concave surface, so that the elastic arm 1ab and the concave surface are separated. During implementations, the elastic piece 2ac can be made from various materials such as rubber as long as the materials can facilitate return of the button rod 2bb′. The concave surface is fixedly matched with the elastic arm 1ab and is a fixed concave surface of the elastic piece 2ac or a concave surface formed by extrusion of the elastic arm 1ab.

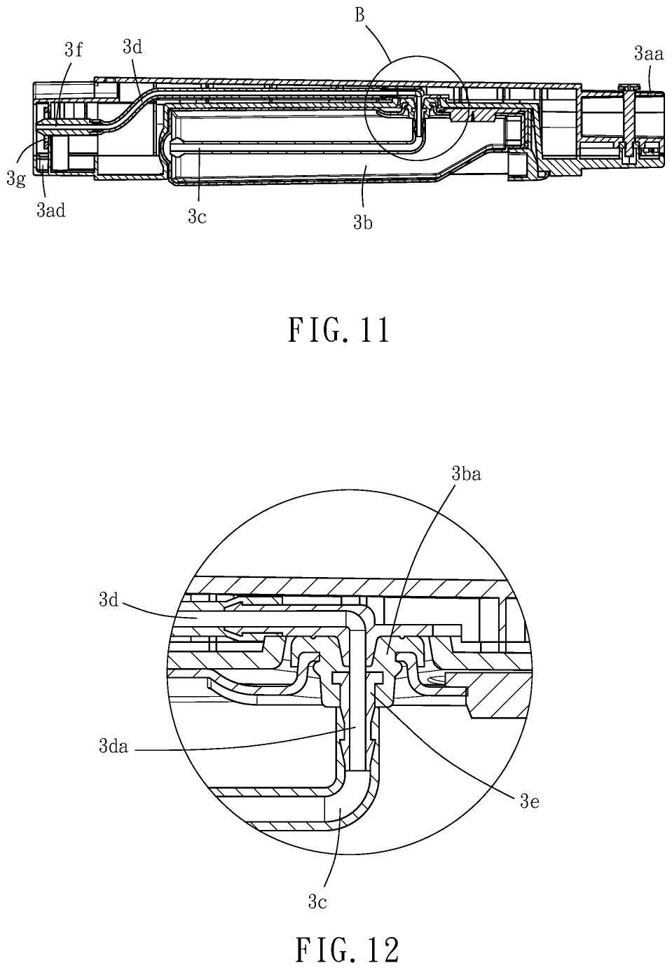

As shown in FIG. 10, FIG. 11, and FIG. 12, the lower rod assembly 3 is provided with a lower rod shell 3a, an insertion part 3aa inserted into the upper rod assembly 2 is formed at one end of the lower rod shell 3a, a mop head insertion groove 3ab allowing the mop head assembly 4 to be inserted therein is formed in the other end of the lower rod shell 3a, and the lower rod shell 3a is provided with a water tank 3b. Preferably, a second bolt hole used for fixing a bolt is formed in the insertion part 3aa. Preferably, a concave water tank bin is arranged on the lower rod shell 3a, and the water tank 3b is detachably arranged in the water tank bin. Preferably, a water-flow guide pipe 3c is arranged in the water tank 3b and has a lower end stretching to the bottom of the water tank 3b and an upper end connected to the side wall of the water tank 3b and extending out of the water tank 3b. Preferably, a main water pipe 3d is arranged in the lower rod shell 3a and has an upper end communicated with the water-flow guide pipe 3c and a lower end extending downwards out of the lower rod shell 3a. Preferably, a water pipe base 3ba is arranged on the side wall of the water tank 3b, a hole is formed in the water pipe base 3ba, the water-flow guide pipe 3c is fixed to the water pipe base 3ba and is communicated with the outside via the hole in the water pipe base 3ba. Preferably, a first rubber plug 3e provided with a flow-guide hole is embedded into the water pipe base 3ba and has an end stretching into the water-flow guide pipe 3c as well as an end fixed to the water pipe base 3ba, the flow-guide hole exactly faces the hole in the water pipe base 3ba, and correspondingly, a slim section 3da to be inserted into the flow-guide hole is formed at the upper end of the main water pipe 3d. Preferably, a second rubber plug 3f having a pipe arranged therein is arranged at the lower end of the main water pipe 3d, and the main water pipe 3d is communicated with the outside through the pipe arranged in the second rubber plug 3f Preferably, the second rubber plug 3f is fixed in the lower rod shell 3a through a fixed base plate 3g. Preferably, the water tank 3b is arranged in the water tank bin through a buckling structure.

In this embodiment, the lower rod shell 3a is used as a main part of the lower rod assembly 3, is inserted into the lower insertion groove 2c in the upper rod shell 2a through the insertion part 3aa, and is fixed through a bolt penetrating through the first bolt hole 2e and the second bolt hole. The lower rod shell 3a is connected with the mop head assembly 4 in an insertion manner through the mop head insertion groove 3ab. The water tank 3b contains water used for cleaning a mop head and is detachably arranged in the water tank bin through the buckling structure to facilitate water supply, water change and maintenance. The water tank 3b is kept smooth relative to the surface of the lower rod shell 3a through configuration of the water tank. bin Water is discharged out of the water tank 3b via the water-flow guide pipe 3c; the lower end of the water-flow guide pipe 3c stretches to the bottom of the water tank 3b, so that water can be completely discharged; and the upper end of the water-flow guide pipe 3c stretches out of the water tank 3b and is connected with the main water pipe 3d, so that water can be discharged through the main water pipe 3d. Due to the fact that water tank 3b needs to be disassembled and taken out from the lower rod shell 3a and the water-flow guide pipe 3c is arranged in the water tank 3b, a connecting structure needs to be arranged between the water-flow guide pipe 3c and the main water pipe 3d to facilitate connection and communication. In view of this, the first rubber plug 3e provided with the flow-guide hole is arranged, and the first rubber plug 3e is communicated and connected with the water-flow guide pipe 3c and is fixed by the water pipe base 3ba. Meanwhile, in this structure, the slim section 3da to be inserted into the flow-guide hole is arranged on the main water pipe 3d, and when the main water pipe 3d is connected with the water-flow guide pipe 3c, the slim section 3da of the main water pipe 3d is inserted into the first rubber plug 3e to fulfill communication with the water-flow guide pipe 3c. When the water tank 3b needs to be taken down, the slim section 3da is pulled out of the first rubber plug 3e, and the first rubber plug 3e closes the hole through elasticity of its own so as to seal a pipe. Similarly, the second rubber plug 3f is arranged at the lower end of the main water pipe 3d and is fixed by the fixed base plate 3g, and in this case, the lower part of the whole main water pipe 3d is fixed. The fixed base plate 3g is of a combined structure formed by a plurality of plates and is used to fix the second rubber plug 3f.

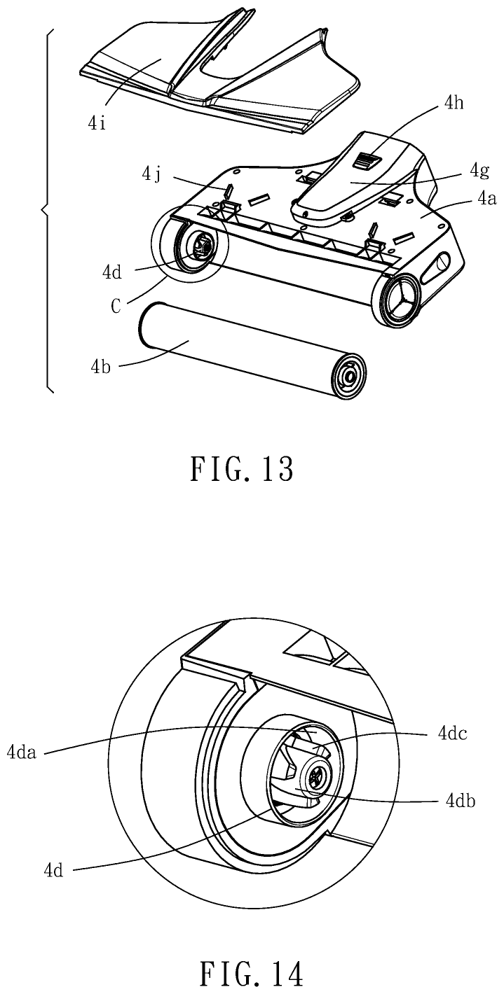

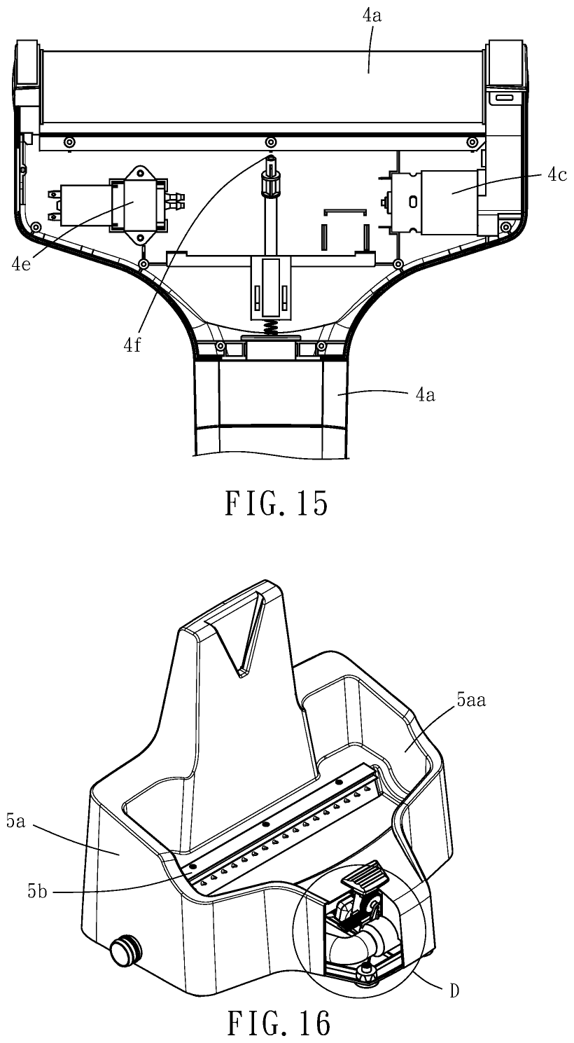

As shown in FIG. 13, FIG. 14, and FIG. 15, the mop head assembly 4 is provided with a mop head shell 4a which is provided with a rotatable cleaning roller 4b. Preferably, a motor 4c used for driving the cleaning roller 4b is arranged in the mop head shell 4a and is connected to the cleaning roller 4b through a transmission assembly. Preferably, the transmission assembly includes a change gear set, a transmission belt, and a roller connector 4d, wherein the motor 4c, the change gear set, the transmission belt, and the roller connector 4d are sequentially connected, and the cleaning roller 4b is assembled to the roller connector 4d rotatably arranged on the mop head shell 4a. Preferably, the roller connector 4d has an end correspondingly connected to a belt wheel of the transmission belt as well as an end provided with the cleaning roller 4b and is arranged on the mop head shell 4a through a bearing. Preferably, a cylindrical groove 4da is formed in the end, connected with the cleaning roller 4b, of the roller connector 4d, a cylinder core 4db used for assembling the cleaning roller 4b is arranged in the cylindrical groove 4da, and assembly protrusions 4dc are arranged on the external wall of the cylinder core 4db. Preferably, the number of the assembly protrusions 4dc is more than one, and the assembly protrusions 4dc are uniformly distributed on the external wall of the cylinder core 4db and are bent toward a circumferential edge of the cylinder core 4db to be arc. Preferably, a water pump 4e used for discharging cleaning water is arranged in the mop head shell 4a and has an output end connected to a nozzle 4f Preferably, the nozzle 4f is arranged on the mop head shell 4a and has a water outlet end stretching out of the mop head shell 4a. Preferably, an opening extending into the mop head shell 4a is formed in the mop head shell 4a, and a surface cover plate 4g is arranged at the opening through a buckling structure and is provided with a button 4h used for unbuckling the buckling structure. Preferably, the mop head shell 4a is provided with a decoration panel 4i which is clamped on the mop head shell 4, and the decoration panel 4i and the surface cover plate 4g are integrally combined to cover the mop head shell 4a.

The structure of the mop head assembly 4 for a segmented mop rod is given in this embodiment. The mop head shell 4a is used as a main part and is provided with related parts such as the cleaning roller 4b and the motor 4c. The cleaning roller 4b rotates to clean the floor and rotates to fulfill self-cleaning as needed. Rotation power of the cleaning roller 4b is supplied by the motor 4c. The rotational speed of the motor 4c is high, while the cleaning roller 4b does not need to rotate at a high speed during work, so that the change gear set is adopted for speed reduction, and the change gear set belongs to the prior art and is not described anymore herein. Due to specific structural configuration of the parts, a certain distance exists between the motor 4c and the cleaning roller 4b driven by the motor 4c to rotate, in this case, the transmission belt is adopted to transmit the rotational speed, and two-stage transmission can be set according to the actual distance and transmission stability, that is to say, two transmission belts can be adopted to perform continuous transmission. The transmission belt belonging to the prior art includes the belt wheel driving the belt to move and is not described anymore herein.

The roller connector 4d is used for assembling the cleaning roller 4b and directly drives the cleaning roller 4b to rotate. To meet the rotation requirement of the roller connector 4d, the roller connector 4d is assembled through the bearing. The cleaning roller 4b is assembled through the cylindrical groove 4da and the cylinder core 4db and is assembled in the cylindrical groove 4da through a corresponding matching structure arranged at one end of the cleaning roller 4b, particularly, the cleaning roller 4b is inserted into the cylindrical groove 4da through the cylinder core 4db, and the assembly protrusions 4dc are arranged according to an engaged structural principle and can drive the cleaning roller 4b to rotate in structure. The edges of the assembly protrusions 4dc are bent to be arc to facilitate assembly and have a circumferential clamping effect while fulfilling axial moving assembly. The water pump 4e is used for pumping cleaning water, and particularly, the cleaning water discharged via the nozzle 4f arranged on the mop head shell 4a is directly sprayed to the cleaning roller 4b for cleaning. The surface cover plate 4g covers the opening of the mop head shell 4a to protect the inside of the mop head shell 4a against interference from the outside, and when the parts in the mop head shell 4a need to be handled, the buckling structure of the surface cover plate 4g is unbuckled through the button 4h. The button 4h is a provided with a spring, is able to return, and pushes the buckling structure to be unbuckled to be released when pressed downwards. The surface cover plate 4g is directly clamped on the buckling structure when assembled, and is then fixed through the buckling structure. The decoration panel 4i is used for covering the mop head shell 4a to fulfill decoration and coverage, and the decoration panel 4i is clamped to be assembled without screws, and after the decoration panel 4i is assembled in this way, no screw can be seen on the whole product in appearance. The specific clamping structure belongs to the prior art, and various other specific structures capable of assembling the decoration panel 4i on the mop head shell 4a can also be adopted. As shown in the figures, a convex rib 4j used for guiding is configured to fulfill blind assembly, and the decoration panel 4i can be accurately positioned by the convex rib 4j and is prevented from deviating so as to be conveniently and rapidly assembled.

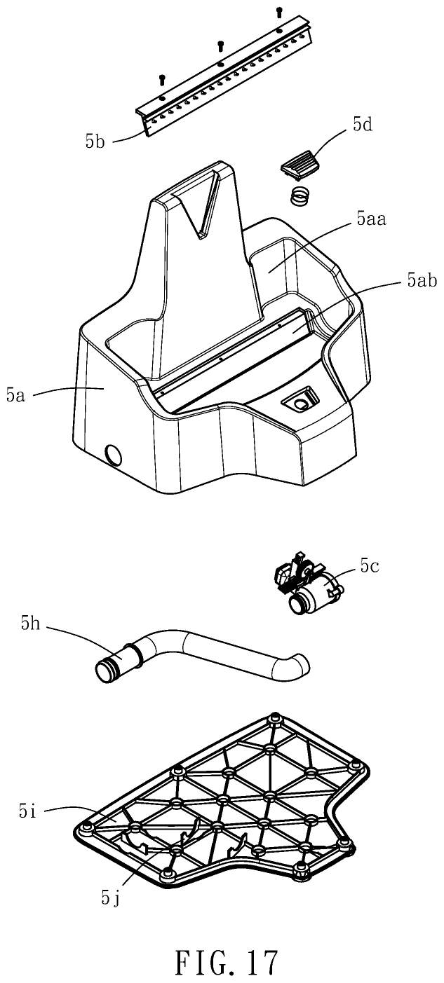

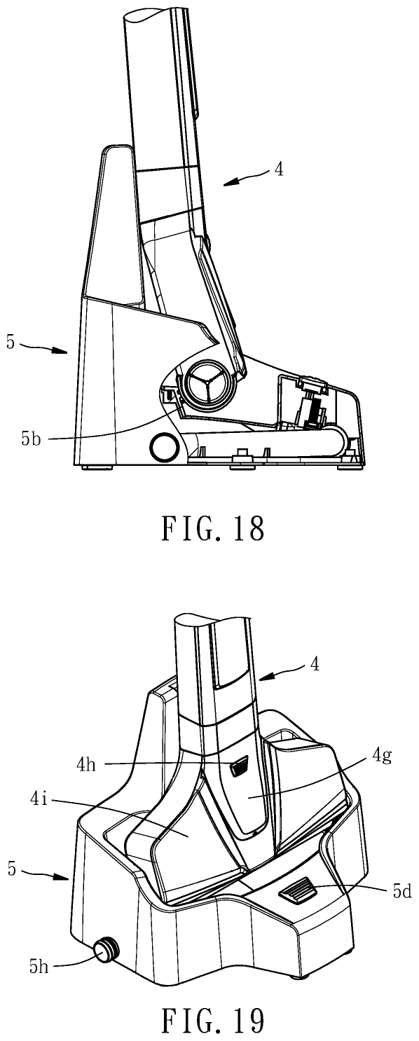

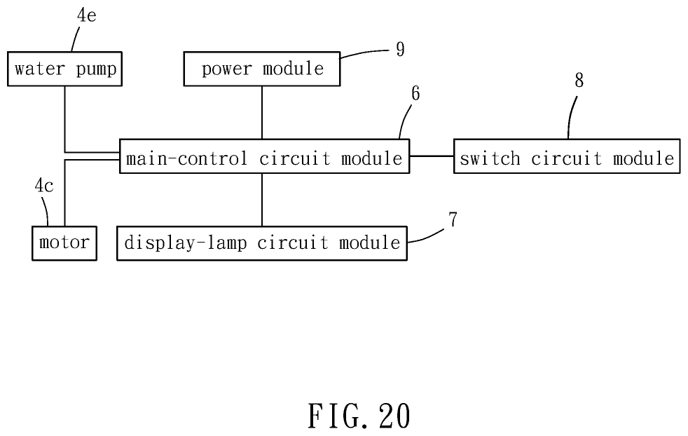

As shown in FIG. 16 to FIG. 19, the cleaning base assembly 5 is provided with a shell part 5a, a cleaning groove 5aa is formed in the upper surface of the shell part 5a, a cleaning assembly used for scrubbing the mop is arranged in the cleaning groove 5aa, and the shell part 5a is provided with a sewage discharge system used for discharging sewage. Preferably, a positioning slot 5ab used for storing the mop head is formed in the cleaning groove 5aa. Preferably, the cleaning assembly includes a water-squeezing scraper strip 5b arranged on the edge of the positioning slot 5ab. Preferably, the sewage discharge system includes a sewage discharge valve 5c having a water inlet end connected into the cleaning groove 5aa as well as a water outlet end extending out of the shell part 5a, and the shell part 5a is provided with a button 5d used for opening the sewage discharge valve 5c.

The specific structure of the cleaning base assembly 5 is given in this embodiment. The shell part 5a is used as a main part of the cleaning base assembly 5, and the cleaning groove 5aa is used for containing water to clean the mop. The cleaning assembly is used for discharging sewage left on the roller of the mop. During implementations, the bottom surface of the cleaning groove 5aa is set to be oblique, so that the sewage in the cleaning groove 5aa can naturally flow out to be discharged. The shell part 5a is formed integrally, and as shown in the figures, the whole upper plate surface the shell part 5a is recessed downwards to form the cleaning groove 5aa, and correspondingly, the shell part 5a is integrally recessed to form the positioning slot 5ab. A main plate surface of the shell part 5a is bent to naturally form a cavity below the shell part 5a to configure related parts of the sewage discharge system. Moreover, a bottom shell plate 5i is arranged at the lower end of the shell part 5a, and the related parts of the sewage discharge system are sealed in the cavity to be protected. In order to realize firmer configuration of a sewage discharge pipe 5h, a fixing clamp plate 5j arranged to fix the sewage discharge pipe 5h. During the implementations, a plate of the shell part 5a integrally protrudes upwards to form a back part 5k, and the mop leans against the back part 5k to be stored more stably and firmly.

As shown in FIG. 20, a circuit system of a preferred embodiment of the invention includes a main-control circuit module 6, a display-lamp circuit module 7, a switch circuit module 8, a power module 9, a motor 4c, and a water pump 4e, wherein the main-control circuit module 6 is used for controlling the whole circuit system, the display-lamp circuit module 7 is used for configuring a display lamp, the switch circuit module 8 used for configuring a switch circuit of the motor 4c and the water pump 4e, the power module 9 is used for supplying power to the whole circuit system, the motor 4c is used for driving a cleaning roller 4b to rotate, the water pump 4e is used for pumping water to clean the cleaning roller 4b, and the display-lamp circuit module 7, the switch circuit module 8, the power module 9, the motor 4c, and the water pump 4e are connected to the main-control circuit module 6.

1. A self-cleaning automatically-stored electrical mop, comprising a mop rod assembly, a mop head assembly arranged at a lower end of the mop rod assembly, and a cleaning base assembly used for storing and cleaning the mop head assembly, wherein:
the mop head assembly includes a mop head shell provided with a rotatable cleaning roller and a motor used for driving the cleaning roller; and the cleaning base assembly includes a shell part, wherein a cleaning groove used for cleaning the cleaning roller is formed in the shell part, a cleaning assembly used for scrubbing the cleaning roller is arranged in the cleaning groove, and the shell part is provided with a sewage discharge system used for discharging sewage.

2. The self-cleaning automatically-stored electrical mop according to claim 1, wherein the motor is connected to the cleaning roller through a transmission assembly, the transmission assembly includes a change gear set, a transmission belt, and a roller connector which are sequentially connected, the roller connector is rotatably arranged on the mop head shell, and the cleaning roller is assembled on the roller connector.

3. The self-cleaning automatically-stored electrical mop according to claim 1, wherein the mop rod assembly includes at least two connecting sections which are detachably connected.

4. The self-cleaning automatically-stored electrical mop according to claim 1, wherein the mop rod assembly includes three connecting sections, the three sections are respectively a handle assembly, an upper rod assembly, and a lower rod assembly which are sequentially and detachably connected, and the mop head assembly is detachably connected to the lower rod assembly.

5. The self-cleaning automatically-stored electrical mop according to claim 4, wherein the handle assembly includes a handle shell, and an insertion section is formed at a lower end of the handle shell and is provided with an elastic arm connected to the upper rod assembly; the upper rod assembly includes an upper rod shell, an upper insertion groove allowing the insertion section to be inserted therein is formed in an end of the upper rod shell, a clamping groove matched with the elastic arm is formed in a side wall of the upper insertion groove, and the upper rod shell is provided with a handle release button used for releasing the elastic arm; the handle release button includes a button cap and a button rod stretching into the clamping groove; the button cap penetrates through a wall plate of the upper rod shell, and a limit protrusion matched with the wall plate is arranged on a lower edge of the button cap; and the upper insertion groove is defined by an insertion groove wall plate, the clamping groove is formed in an internal wall of the insertion groove wall plate, the button rod is sleeved with a return spring, and the return spring has an end abutting against the button cap as well as an end abutting against an external surface of the insertion groove wall plate.

6. The self-cleaning automatically-stored electrical mop according to claim 5, wherein an elastic piece having a concave surface as the clamping groove is embedded into a side wall of the insertion groove, and the handle release button includes a button cap and a button rod which extrudes the elastic piece to deform, so that the elastic arm is disengaged from the concave surface to be released.

7. The self-cleaning automatically-stored electrical mop according to claim 6, wherein the upper rod assembly includes the upper rod shell, and the lower rod assembly includes a lower rod shell; and an insertion part inserted into the upper rod shell is formed at an end of the lower rod shell, a lower insertion groove allowing the insertion part to be inserted therein is correspondingly formed in an end of the upper rod shell, and a mop head insertion groove allowing the mop head shell to be inserted therein is formed in an end of the lower rod shell.

8. The self-cleaning automatically-stored electrical mop according to claim 7, wherein the insertion part is fixed in the lower insertion groove through a bolt.

9. The self-cleaning automatically-stored electrical mop according to claim 1, wherein a water pump used for discharging cleaning water is arranged on the mop head shell and has an output end connected to a nozzle arranged on the mop head shell, and a water outlet end of the nozzle stretches out of the mop head shell.

10. The self-cleaning automatically-stored electrical mop according to claim 1, wherein a positioning slot used for storing the cleaning roller is formed in the cleaning groove.

11. The self-cleaning automatically-stored electrical mop according to claim 1, wherein a bottom surface of the cleaning groove is oblique.

12. The self-cleaning automatically-stored electrical mop according to claim 11, wherein the cleaning assembly includes a water-squeezing scraper strip arranged on an edge of a positioning slot.

13. A method for using the electrical mop according to claim 12, comprising the following steps:
1, using the cleaning roller to clean a floor;
2, placing the mop head assembly into the cleaning groove after usage, and placing the cleaning roller into the positioning slot, wherein the cleaning roller is submerged in water in the cleaning groove;
3, starting the motor to drive the cleaning roller to rotate to be cleaned, and scrubbing the cleaning roller by the water-squeezing scraper strip at the same time; and
4, discharging sewage out of the cleaning groove.

14. The method for using the electrical mop according to claim 13, wherein the water pump is started to spray water or cleaning solutions to the floor to be cleaned before step 1.
